(19) United States
(12) Patent Application Publication
(10) Pub. No.: US 2025/0209034 A1
(43) Pub. Date: Jun. 26, 2025

(54) INFORMATION TRANSCEIVING METHOD AND INFORMATION TRANSCEIVING SYSTEM

(71) Applicant: Realtek Semiconductor Corp., HsinChu (TW)

(72) Inventor: Yueh-Hsing Huang, HsinChu (TW)

(73) Assignee: Realtek Semiconductor Corp., HsinChu (TW)

(21) Appl. No.: 18/988,927

(22) Filed: Dec. 20, 2024

(30) Foreign Application Priority Data
Dec. 26, 2023 (TW) 112150818

(51) Int. Cl. G06F 13/42; G06F 13/38

(52) U.S. Cl. CPC G06F 13/4295; G06F 13/387

(57) ABSTRACT

An information transceiving method, applied to an information transceiving system with a transmission device and a reception device, the transmission device comprising a first TX input interface following a first transceiving specification and a second TX input interface following a second transceiving specification, the reception device comprising a first RX output interface following a third transceiving specification. The information transceiving method comprises: (a) receiving first information by the first TX input interface and receiving second information by the second TX input interface; (b) performing classifying according to information characteristics of the first information and the second information by the transmission device, to acquire a first classifying result of the first information and a second classifying result of the second information; and (c) transmitting the first information or the second information to the first RX output interface according to the first classifying result and the second classifying result, by the transmission device.

### BACKGROUND OF THE INVENTION

### 1. FIELD OF THE INVENTION

The present invention relates to an information transceiving method and an information transceiving system, and particularly relates to an information transceiving method and an information transceiving system which use transmission ends with different interfaces.

### 2. DESCRIPTION OF THE PRIOR ART

Modern electronic devices use a variety of transceiving specification to transmit information, such as HDMI (High Definition Multimedia Interface), USB-C (universal serial bus type C interface), PCIe (Peripheral Component Interconnect Express). Users usually need corresponding connection cables and electronic devices must have the same interface. For example, if a user wants to connect a DVD player to the HDMI interface of a TV, the DVD player must have an HDMI interface and the user must have a corresponding HDMI cable. For another example, if a user wants to connect a hard drive to the USB-C interface of a computer, the hard drive must have a USB-C interface and the user must have a corresponding USB-C cable. Alternatively, users can use an adapting device (such as an adapter cable or adapter) to allow information transceiving between interfaces using different transceiving specification. However, traditional adapting devices usually only perform one-to-one conversion, that is, converting information corresponding to one transceiving specification into information corresponding to another t transceiving specification. These restrictions make it inconvenient for users to use various electronic devices.

### SUMMARY OF THE INVENTION

One objective of the present invention is to provide an information transceiving system in which the transmission end can comprise a variety of different interfaces.

Another objective of the present invention is to provide an information transceiving method in which the reception end can comprise a variety of different interfaces.

One embodiment of the present invention discloses an information transceiving method, applied to an information transceiving system with a transmission device and a reception device, the transmission device comprising a first TX input interface following a first transceiving specification and a second TX input interface following a second transceiving specification, the reception device comprising a first RX output interface following a third transceiving specification. The information transceiving method comprises: (a) receiving first information by the first TX input interface and receiving second information by the second TX input interface; (b) performing classifying according to information characteristics of the first information and the second information by the transmission device, to acquire a first classifying result of the first information and a second classifying result of the second information; and (c) transmitting the first information or the second information to the first RX output interface according to the first classifying result and the second classifying result, by the transmission device.

Another embodiment of the present invention discloses an information transceiving system comprising a transmission device and a reception device. The transmission device comprises: a first processor; a first TX input interface following a first transceiving specification; a second TX input interface following a second transceiving specification. The reception device comprises a second processor; a first RX output interface following a third transceiving specification.

The first processor and the second processor are configured to perform an information transceiving method which comprises: (a) receiving first information by the first TX input interface and receiving second information by the second TX input interface; (b) performing classifying according to information characteristics of the first information and the second information by the transmission device, to acquire a first classifying result of the first information and a second classifying result of the second information; and (c) transmitting the first information or the second information to the first RX output interface according to the first classifying result and the second classifying result, by the transmission device.

In view of above-mentioned embodiments, the present invention provides an information transceiving system and an information transceiving method in which the transmission end can comprise a variety of different interfaces. The information transceiving system can select an appropriate transmission method according to the type of information, thereby improving convenience and stability of information transceiving.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an information transceiving system according to an embodiment of the present invention.

FIG. 2 is a schematic diagram illustrating an information transceiving system according to another embodiment of the present invention.

FIG. 3 is a schematic diagram illustrating how to classify information from input interfaces of different transmission ends according to an embodiment of the present invention.

FIG. 4 illustrates a schematic diagram of packets used by a transmission device according to an embodiment of the present invention.

FIG. 5 illustrates a block diagram of a first FIFO (first-in-first-out) buffer used in a transmission device according to an embodiment of the present invention.

FIG. 6 illustrates a block diagram of a second FIFO buffer used by a reception device according to an embodiment of the present invention.

FIG. 7 and FIG. 8 illustrate practical examples of information transceiving systems according to different embodiments of the present invention.

FIG. 9 illustrates a flow chart of an information transceiving method according to an embodiment of the present invention.

### DETAILED DESCRIPTION

Several embodiments are provided in following descriptions to explain the concept of the present invention. Besides, the method in following descriptions can be performed by programs stored in a non-transitory computer readable recording medium by a processing circuit. The non-transitory computer readable recording medium can be, for example, a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices.

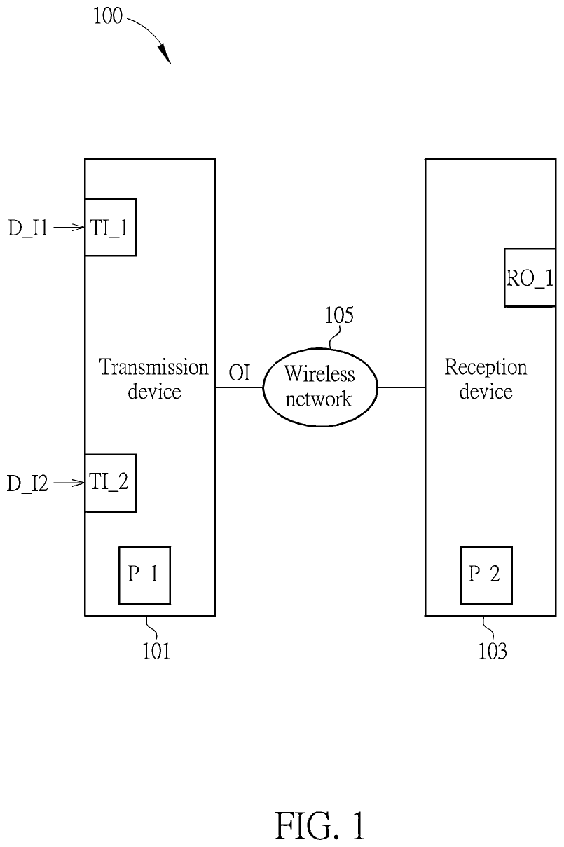

FIG. 1 is a schematic diagram illustrating an information transceiving system according to an embodiment of the present invention. As shown in FIG. 1, the information transceiving system 100 comprises a transmission device 101 and a reception device 103. In one embodiment, the functions of the transmission device 101 and the reception device 103 may be interchanged, that is, the transmission device 101 is used as a reception device and the reception device 103 is used as a transmission device. The transmission device 101 comprises a first transmission input interface TI_1 following a first transceiving specification and a second transmission input interface TI_2 following a second transceiving specification. The reception device 103 comprises a first RX output interface RO_1 following a third transceiving specification. The first transceiving specification is different from the second transceiving specification. In one embodiment, the third transceiving specification is different from the first transceiving specification and the second transceiving specification. For example, the first transceiving specification is HDMI, the second transceiving specification is PCI-e, and the third transceiving specification is USB-C. In another embodiment, the third transceiving specification is the same as one of the first transceiving specification and the second transceiving specification. For example, the first transceiving specification is USB-C, the second transceiving specification is PCI-e, and the third transceiving specification is USB-C.

If the output information transmitted by the transmission device 101 originally follows the transceiving specification which is used by the first RX output interface RO_1, the first RX output interface RO_1 can directly receive the output information and transmits the output information to the electronic device connected (wired or wirelessly) to the first RX output interface RO_1. On the contrary, if the output information OI transmitted by the transmission device 101 follows a transceiving specification different from the transceiving specification used by the first RX output interface RO_1, the reception device 103 must convert the output information into the format which the first RX output interface RO_1 can receive, Next, the converted output information OI is received by the first RX output interface RO_1 and then transmitted to the electronic device connected to the first RX output interface RO_1. Please also note that the information stated in the present invention means all signals transmitted by the transmission devices 101, which may comprise information used to indicate or specify the access address, such as headers, and may comprise data. The information may also represent a check code, such as a CRC (Cyclic redundancy check) code. In the following embodiments, information is transmitted in packet format, so the transmission device 101 classifies each packet.

In the embodiment of FIG. 1, the transmission device 101 comprises a first processor P_1 (e.g., a CPU, a MCU or a processing circuit), which can be used to control the action of the transmission device 101. The reception device 103 comprises a second processor P_2, which can be used to control the actions of the reception device 103. Please also note that in the embodiment of FIG. 1, information transceiving between the transmission device 101 and the reception device 103 is performed through a wireless network 105. However, information transceiving between the transmission device 101 and the reception device 103 can also be performed through a wired connection. The first transmission input interface TI_1 receives the first information D_I1 and the second transmission input interface TI_2 receives the second information D_I2. The transmission device 101 performs classifying according to the information characteristics of the first information D_I1 and the second information D_I2 to obtain a first classifying result of the first information D_I1 and a second classifying result of the second information D_I2. The transmission n device 101 correspondingly transmits the first information D_I1 or the second information D_I2 to the first RX output interface RO_1 according to the first classifying result and the second classifying result.

In one embodiment, the classifying result comprises at least one of the following parameters: information synchronization type, required immediacy, and required completeness. For example, the classifying results comprise information synchronization type and required immediacy, or required immediacy and required completeness. The information synchronization type refers to the synchronization method used by the information. For example, if the information is audio and video information following the HDMI specification or the USB specification, the audio and video information is synchronized according to the horizontal synchronization signal Hsync. For another example, if the information follows the General Control Packet specified by HDMI or the information follows the HDCP (High-Bandwidth Digital Content Protection) specification, the information is transmitted based on the vertical synchronization signal Vsync. After the information is classified according to the information synchronization type, the transmission device 101 can quickly know how to synchronize the information through the classifying results while transmitting or the reception device 103 can quickly know how to synchronize the information through the classifying results while receiving, so as to increase the accuracy of transmitting information.

The required immediacy is the tolerable delay of the information. For example, if the information from the user input interface (such as keyboard or mouse) is delayed, the user will experience a more obvious delay. Alternatively, if the control command which the IrDA (Infrared Data Association) specification and is from a remote control is delayed, the user will experience considerable inconvenience. Therefore, such type of information has a high required immediacy.

The required completeness is the tolerable amount of information loss, such as the tolerable amount of packet loss. For example, if the information is audio and video information following HDMI, Display port or USB, too much information loss will affect the integrity of the image or sound effects, so this type of information has a high required completeness. On the contrary, if the information comes from the mouse, the mouse's trajectory is usually composed of continuous movements, so even if part of the movement output by the mouse is lost, the trajectory can still maintain most of its integrity, so this type of information has a low required completeness.

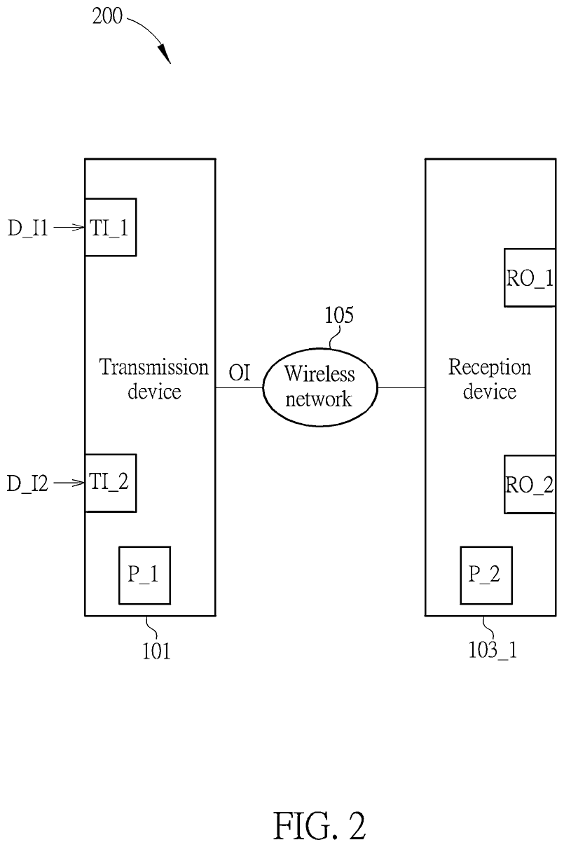

FIG. 1 illustrates a many-to-one information transceiving system 100. However, the information transceiving system provided by the present invention can also be many-to-many. FIG. 2 is a schematic diagram illustrating an information transceiving system according to another embodiment of the present invention. As shown in FIG. 2, the information transceiving system 200 comprises a transmission device 101 and a reception device 103_1. In addition to the first RX output interface RO_1, the reception device 103_1 further comprises a second RX output interface RO_2 following a fourth transceiving specification. The transmission device 101 transmits the first information D_I1 and the second information D_I2 to the first RX output interface RO_1 or the second RX output interface RO_2 according to the first classifying result and the second classifying result. In one embodiment, the third transceiving specification and the fourth transceiving specification are different, and the first transceiving specification, the second transceiving specification, the third transceiving specification and the fourth transceiving specification are all different. Other detail characteristics of the second RX output interface RO_2 have been described in the relevant descriptions of FIG. 1, thus are omitted for brevity here.

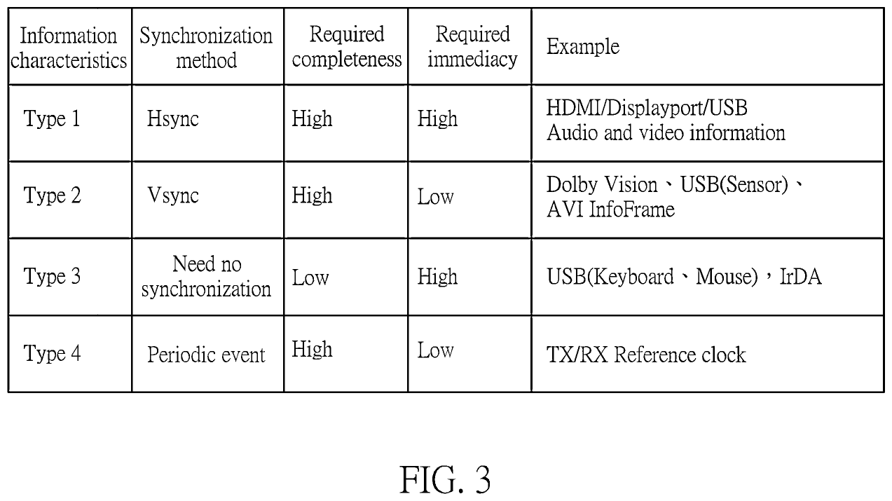

FIG. 3 is a schematic diagram illustrating how to classify information from input interfaces of different transmission ends according to an embodiment of the present invention. In the example in FIG. 3, four types are used for illustration. Type 1 information is classified based on the horizontal synchronization signal Hsync, which requires a high required completeness and a high required immediacy, such as audio and video information following the HDMI specification, the Display port specification, or the USB specifications. Type 2 information is classified based on the vertical synchronization signal Vsync. The required completeness is high and the required immediacy is low, such as audio and video information that follows the Dolby Vision specification and sensor signals that follows the USB specification, or InfoFrame in the HDMI specification.

Type 3 information does not need to be synchronized, the required completeness is low and the required immediacy is high, such as input interface information following the USB specification (such as information provided by a keyboard or mouse), or information that follows the IrDA specification. The synchronization method of type 4 information is based on periodic events. For example, a signal in a specific format will be generated every 100 ms. Type 4 information requires a high required completeness and a low required immediacy, such as the reference clock signal used by the transmission device 101 or the reception device 103. However, please note that FIG. 3 is only used to illustrate how to classify information and does not mean to limit the present invention. For example, information can be classified into more or fewer types rather than limited to four types. In another example, required completeness and required immediacy can be divided into more levels rather than just high and low levels. Besides, corresponding to different devices or transceiving requirements, the same information can also be set to have different required completeness or required immediacy for different devices. The concept of the present invention can also be applied to other information, such as audio from a microphone, information following HDCP specification, audio from an AUX audio line, or CEC (Consumer Electronics Control) commands. In addition, according to the example in FIG. 3, even information that follows the same specifications may be classified into different types because of its different information characteristics. For example, information which follows the HDMI specification but has different functions, may be classified into different types.

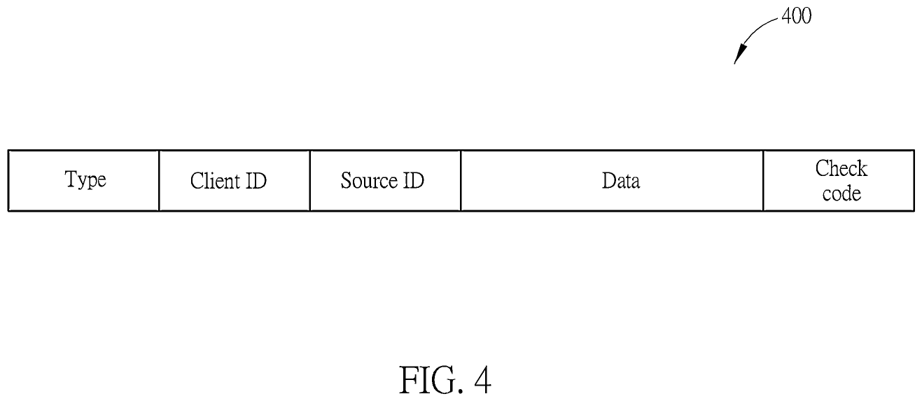

As mentioned above, the information transmitted by the transmission device 101 can be transmitted in a packet format. FIG. 4 illustrates a schematic diagram of the packets 400 used by a transmission device according to an embodiment of the present invention. As shown in FIG. 4, packet 400 contains classifying results, Client ID, Source ID, data and check code. The classifying result is the result obtained after classifying the information in the aforementioned embodiments. The Client ID represents the receiving output interface to which the information is sent, and the Source ID represents the transmission input interface from which the information comes. The data is the data that the transmission device 101 wants to transmit to the reception device 103, such as video data or audio data. The check code is used by the reception device 103 to confirm whether the data it receives is correct, and may be the aforementioned CRC, for example.

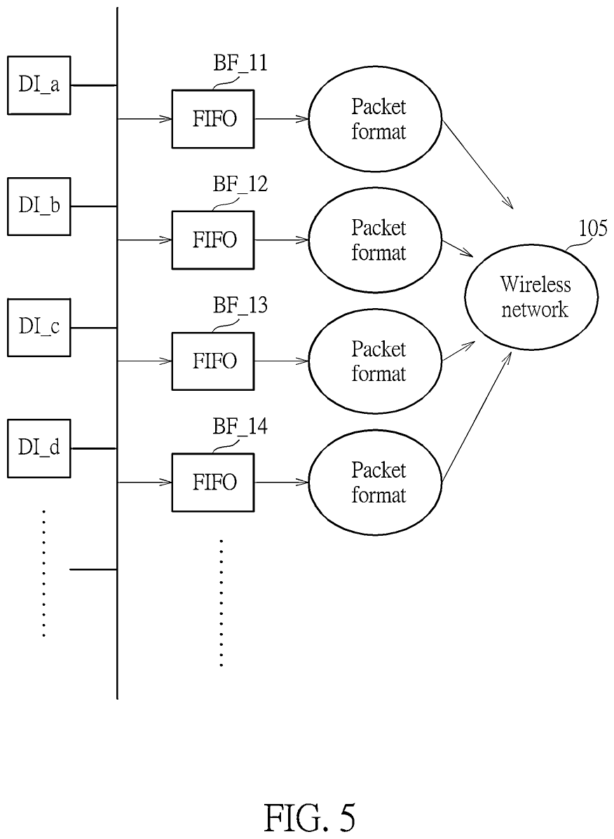

In one embodiment, the transmission device 101 comprises a plurality of first first-in-first-out (FIFO) buffers. In such case, the transmission device 101 buffers the portions of the first information D_I1 and the second information D_I2 which have the same classifying results into the same FIFO buffer, and then transmit them to the RX output interface. FIG. 5 illustrates a block diagram of a first FIFO buffer used in a transmission device according to an embodiment of the present invention. As shown in FIG. 5, the transmission device 101 comprises a plurality of first FIFO buffers BF_11, BF_12, BF_13 and BF_14. After receiving the information DI_a, DI_b, DI_c . . . from the transmission input interface following different transceiving specifications, the transmission device 101 classifies the information DI_a, DI_b, DI_c, and then buffers the information with the same classifying result into an identical FIFO buffer. For example, type 1 information is buffered in the first FIFO buffer BF_11 and type 2 information is buffered in the first FIFO buffer BF_12.

In one embodiment, the transmission device 101 reads the information from the first FIFO buffer BF_11, BF_12, BF_13 or BF_14 and transmits the information through the wireless network 105 in a packet format. The transmission device 101 transmits information in different transmission methods corresponding to different classifying results. For example, the synchronization method of type 1 information in FIG. 3 is based on the horizontal synchronization signal Hsync. Therefore, the transmission device 101 performs synchronization based on the horizontal synchronization signal Hsync when transmitting type 1 information, or the reception device 103 performs synchronization based on the horizontal synchronization signal Hsync when receiving type 1 information. For another example, the type 1 information in FIG. 3 has a high required completeness. Therefore, when transmitting the type 1 information, the transmission device 101 completes the transmission of type 1 information which has a larger data amount, before transmitting other types of information to ensure the completeness thereof. Alternatively, a stronger check code is provided when transmitting the type 1 information to ensure the completeness thereof. Further, the same type 1 information may be transmitted for several times to ensure its completeness. For another example, the type 1 information in FIG. 3 has a high required immediacy, so the transmission device 101 gives a high priority for transmitting the type 1 information buffered in the first FIFO buffer BF_11.

In another embodiment, the reception device 103 comprises a plurality of second FIFO buffers. In such case, when the reception device 103 receives the output information from the transmission device 101, it buffers output information to a corresponding one of the second FIFOs according the first RX output interface or the second RX output interface which the output information to is transmitted to. Next, the output information is transmitted to the first RX output interface or the second RX output interface which the output information is to be transmitted to. The output information here is the information that the transmission device 101 first classifies and then transmits through the wireless network 105 in the aforementioned embodiments.

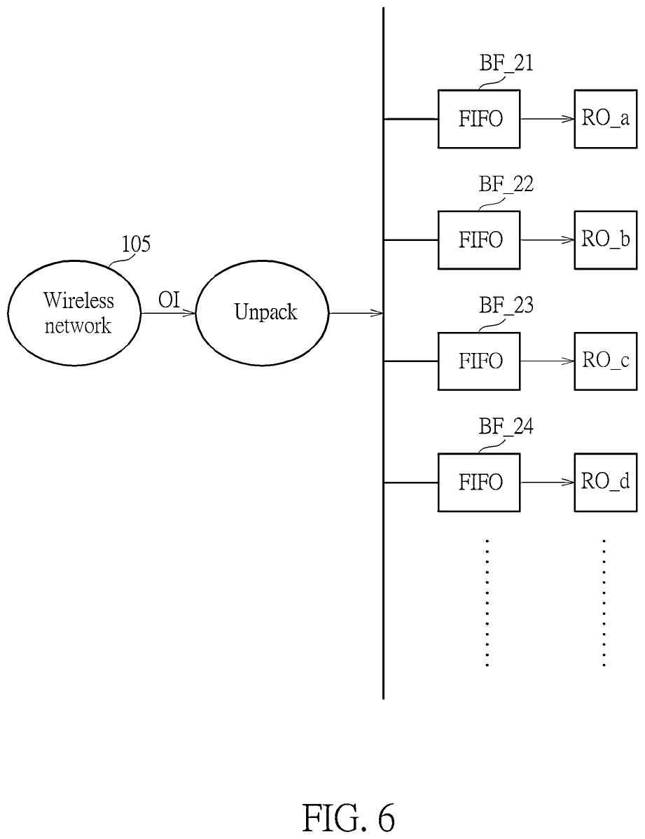

FIG. 6 illustrates a block diagram of a second FIFO buffer used by a reception device according to an embodiment of the present invention. As shown in FIG. 6, the reception device 103 comprises a plurality of second FIFO buffers BF_21, BF_22, BF_23 and BF_24, which respectively correspond to the RX output interfaces RO_a, RO_b, RO_c and RO_d. As above-mentioned, when the reception device 103 receives the output information from the transmission device 101, it buffers output information to a corresponding one of the second FIFOs according the first RX output interface or the second RX output interface which the output information to is transmitted to. Next, the output information is transmitted to the first RX output interface or the second RX output interface. For example, the output information OI to be transmitted to the RX output interface RO_a is buffered in the corresponding second FIFO buffer BF_21, and the output information OI to be transmitted to the RX output interface RO_b is buffered in the corresponding second FIFO buffer BF_22. Then, the information in the second FIFO buffer BF_21 is transmitted to the RX output interface RO_a according to the transceiving specification which the RX output interface RO_a follows. Similarly, the information in the second FIFO buffer BF_22 is transmitted to the RX output interface RO_b according to the transceiving specification which the RX output interface RO_b follows.

In addition to the transceiving methods described in FIG. 5 and FIG. 6, other conventional transceiving methods can also be used in the present invention. For example, an arbitrator in conventional data transceiving methods can be used to decide which one to send or receive first based on the required immediacy of the information. Alternatively, in one embodiment, the transmission may be started after the amount of information in the first FIFO buffer is accumulated to a predetermined amount.

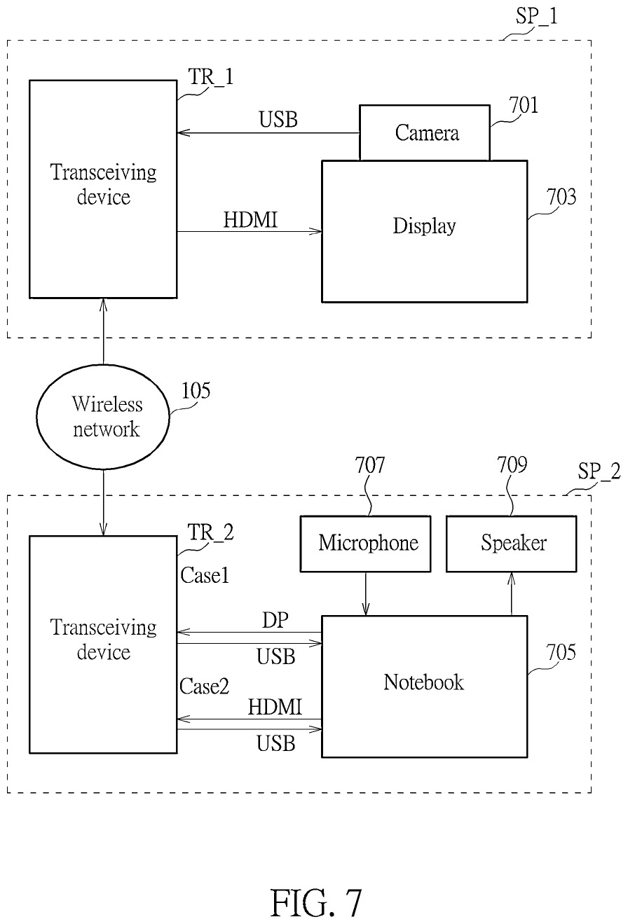

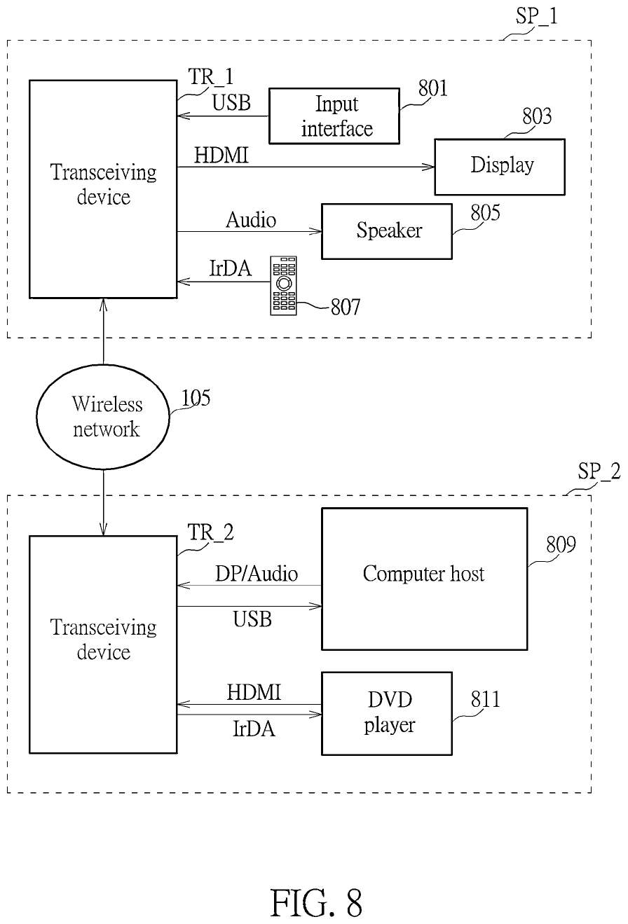

The above-mentioned embodiments can be used in a variety of electronic devices. FIG. 7 and FIG. 8 illustrate practical examples of information transceiving systems according to different embodiments of the present invention. In the example of FIG. 7, the transceiving device TR_1, the camera 701 and the display 703 are located in a first space SP_1, while the transceiving device TR_2, the notebook 705, the microphone 707 and the speaker 709 are located in a second space SP_2. The first space SP_1 and the second space SP_1 can be different rooms, different buildings, different cities or different countries. In the embodiment of FIG. 7, the transceiving devices TR_1 and TR_2 can be used as the aforementioned transmission device 101 and reception device 103, and their transmission and reception functions can be interchanged. Specifically, when the notebook 705 wants to receive information from the device in the first space SP_1, the transceiving device TR_1 serves as the transmission device and the transceiving device TR_2 serves as the reception device. On the contrary, when the notebook 705 wants to transmit information to the device in the second space SP_2, the transceiving device TR_1 serves as the reception device and the transceiving device TR_2 serves as the transmission device.

In the example of FIG. 7, the camera 701 is connected to the USB interface of the transceiving device TR_1 and the display 703 is connected to the HDMI interface of the transceiving device TR_1. In one embodiment (Case 1), the notebook 705 is connected to the Display Port interface and the USB interface of the transceiving device TR_2. In such case, the notebook 705 can receive the images captured by the camera 701 via the USB interface, and if the camera 701 also has a microphone function, the notebook 705 can also receive the audio received by the camera 701 via the USB interface and transmit it through the USB interface. Afterwards, the audio may be played through speaker 709. The notebook 705 can also transmit the screen displayed by itself and the audio received from the microphone 707 to the display 703 through the Display Port interface. In another embodiment (Case 2), the notebook 705 is connected to the HDMI interface and the USB interface of the transceiving device TR_2. In such case, the notebook 705 can receive the images captured by the camera 701 via the USB interface. The notebook 705 can also transmit the image displayed by itself and the audio received from the microphone 707 to the display 703 through the HDMI interface.

In the embodiment of FIG. 8, the transceiving device TR_1, the input interface 801 (such as a keyboard or mouse), the display 803, the speaker 805 and the remote control 807 are located in the first space SP_1. Also, the computer host 809 and the DVD player 811 are located in the second space SP_2. The first space SP_1 and the second space SP_2 are different rooms in the same building in this example. The input interface 801 is connected to the USB interface of the transceiving device TR_1, the display 803 is connected to the HDMI interface of the transceiving device TR_1, and the speaker 805 is connected to the recording interface (e.g., Audio interface) of the transceiving device TR_1. The remote control 807 can transmit control signals to the IrDA interface of the transceiving device TR_1 through a wireless method. The computer host 809 is connected to the USB interface, the Display port interface and the recording interface of the transceiving device TR_2. The DVD player 811 is connected to the HDMI interface of the transceiving device TR_2 and can receive control signals from the IrDA interface of the transceiving device TR_2.

In the embodiment of FIG. 8, the user in the first space SP_1 can input control instructions to the computer host 809 through the input interface 801, so that the computer host 809 transmits audio and video data to the display 803, or transmits audio information to the speaker 805. In addition, the user in the first space SP_1 can also send control instructions to the DVD player 811 through the remote control 807, so that the DVD player 811 transmits audio and video data to the display 803.

Based on above-mentioned embodiments, an information transceiving method can be acquired, which is used in an information transceiving system (such as the information transceiving system 100) having a transmission device and a reception device. The transmission device comprises a first TX input interface following a first transceiving specification and a second TX input interface following a second transceiving specification, and the reception device comprises a first RX output interface following a third transceiving specification.

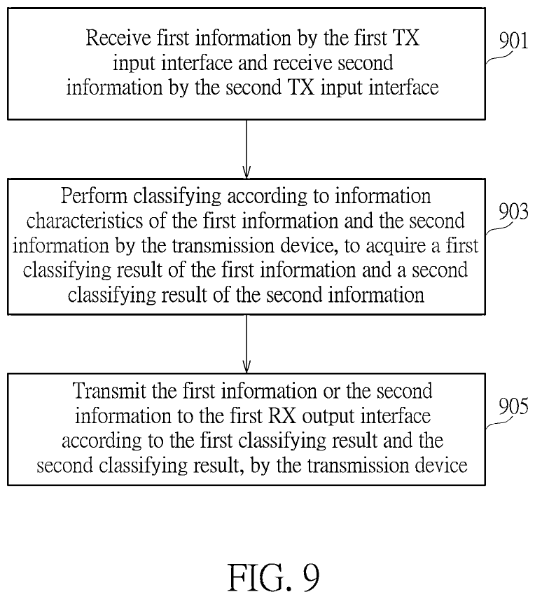

The information transceiving method comprises following steps shown in FIG. 9:

### Step 901

Receive first information by the first TX input interface (for example, TI_1) and receive second information by the second TX input interface (for example, TI_2).

### Step 903

Perform classifying according to information characteristics of the first information and the second information by the transmission device, to acquire a first classifying result of the first information and a second classifying result of the second information

### Step 905

Transmit the first information or the second information to the first RX output interface (for example, RO_1) according to the first classifying result and the second classifying result, by the transmission device.

The reception device may comprise a plurality of RX output interfaces, such as the embodiment shown in FIG. 2. Other detail steps have been described in the above-mentioned embodiments thus are omitted for brevity here.

In view of above-mentioned embodiments, the present invention provides an information transceiving system and an information transceiving method in which the transmission end can comprise a variety of different interfaces. The information transceiving system can select an appropriate transmission method according to the type of information, thereby improving convenience and stability of information transceiving.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An information transceiving method, applied to an information transceiving system with a transmission device and a reception device, the transmission device comprising a first TX input interface following a first transceiving specification and a second TX input interface following a second transceiving specification, the reception device comprising a first RX output interface following a third transceiving specification, the information transceiving method comprising:
(a) receiving first information by the first TX input interface and receiving second information by the second TX input interface;
(b) performing classifying according to information characteristics of the first information and the second information by the transmission device, to acquire a first classifying result of the first information and a second classifying result of the second information; and
(c) transmitting the first information or the second information to the first RX output interface according to the first classifying result and the second classifying result, by the transmission device.

2. The information transceiving method of claim 1, wherein the step (b) performs classifying according to information synchronization types of the first information and the second information.

3. The information transceiving method of claim 1, wherein the step (b) performs classifying according to required immediacy of the first information and the second information.

4. The information transceiving method of claim 1, wherein the step (b) performs classifying according to required completeness of the first information and the second information.

5. The information transceiving method of claim 1, wherein the transmission device comprises a plurality of first FIFOs, wherein the step (c) further comprises:
buffering information of the first information and the second information which have identical buffering results to an identical one of the first FIFOs, and then transmitting the information to the first RX output interface.

6. The information transceiving method of claim 1, wherein the reception device further comprises a second RX output interface following a fourth transceiving specification, wherein the step (c) further comprises:
transmitting the first information and the second information to the first RX output interface or the second RX output interface according to the first classifying result and the second classifying result.

7. The information transceiving method of claim 6, wherein the transmission device comprises a plurality of second FIFOs, wherein the information transceiving method further comprises:
buffering output information to a corresponding one of the second FIFOs according the first RX output interface or the second RX output interface which the output information is to be transmitted to, while the reception receiving the output information from the transmission device; and
transmitting the output information to the first RX output interface or the second RX output interface which the output information is to be transmitted to.

8. The information transceiving method of claim 6, wherein the third transceiving specification the and fourth transceiving specification are different transceiving specification, wherein the first transceiving specification, the second transceiving specification, the third transceiving specification and the fourth transceiving specification are different transceiving specification.

9. The information transceiving method of claim 1, wherein the third transceiving specification is different from the first transceiving specification and the second transceiving specification.

10. The information transceiving method of claim 1, wherein the step (c) classifies the first information to information of different types.

11. An information transceiving system, comprising:
a transmission device, comprising:
a first processor;
a first TX input interface following a first transceiving specification;
a second TX input interface following a second transceiving specification;
a reception device, comprising:
a second processor;
a first RX output interface following a third transceiving specification;
wherein the first processor and the second processor are configured to perform an information transceiving method which comprises:
(a) receiving first information by the first TX input interface and receiving second information by the second TX input interface;
(b) performing classifying according to information characteristics of the first information and the second information by the transmission device, to acquire a first classifying result of the first information and a second classifying result of the second information; and
(c) transmitting the first information or the second information to the first RX output interface according to the first classifying result and the second classifying result, by the transmission device.

12. The information transceiving system of claim 11, wherein the step (b) performs classifying according to information synchronization types of the first information and the second information.

13. The information transceiving system of claim 11, wherein the step (b) performs classifying according to required immediacy of the first information and the second information.

14. The information transceiving system of claim 11, wherein the step (b) performs classifying according to required completeness of the first information and the second information.

15. The information transceiving system of claim 11, wherein the transmission device comprises a plurality of first FIFOs, wherein the step (c) further comprises:
buffering information of the first information and the second information which have identical buffering results to an identical one of the first FIFOs, and then transmitting the information to the first RX output interface.

16. The information transceiving system of claim 11, wherein the reception device further comprises a second RX output interface following a fourth transceiving specification, wherein the step (c) further comprises:
transmitting the first information and the second information to the first RX output interface or the second RX output interface according to the first classifying result and the second classifying result.

17. The information transceiving system of claim 16, wherein the transmission device comprises a plurality of second FIFOs, wherein the information transceiving method further comprises:
buffering output information to a corresponding one of the second FIFOs according the first RX output interface or the second RX output interface which the output information is to be transmitted to, while the reception receiving the output information from the transmission device; and
transmitting the output information to the first RX output interface or the second RX output interface which the output information is to be transmitted to.

18. The information transceiving system of claim 16, wherein the third transceiving specification and the fourth transceiving specification are different transceiving specification, wherein the first transceiving specification, the second transceiving specification, the third transceiving specification and the fourth transceiving specification are different transceiving specification.

19. The information transceiving system of claim 11, wherein the third transceiving specification is different from the first transceiving specification and the second transceiving specification.

20. The information transceiving system of claim 11, wherein the step (c) classifies the first information to information of different types.
